(19) United States
(12) Patent Application Publication
(10) Pub. No.: US 2011/0285113 A1
(43) Pub. Date: Nov. 24, 2011

(54) LOCATING STRUCTURE OF HANDCART

(76) Inventor: Chung-Shiu SU, Lu-Chu Shiang (TW)

(21) Appl. No.: 12/784,101

(22) Filed: May 20, 2010

(51) Int. Cl. B62B 3/02

(52) U.S. Cl. 280/654

(57) ABSTRACT

A locating structure of a handcart includes a main frame, two side rods and a locating rod. The main frame includes a pair of longitudinal rods. The two side rods are pivotally connected to the longitudinal rods of the main frames, respectively. Each side rod has a stop section which is spaced from the longitudinal rod. The locating rod is pivotally connected to the main frame. The locating rod has a pair of extension sections to engage with the stop sections of the two side rods when the two side rods and the locating rod are unfolded.

### BACKGROUND OF THE INVENTION

1. Field of the Invention

This invention relates to a locating structure of a handcart, and more particularly to a handcart with a locating rod which is located between two side rods. When the two side rods are unfolded, the locating rod engages with the two side rods to prevent the two side rods from folding inadvertently and to support the handcart.

2. Description of the Relative Prior Art

The handcarts currently on the market are either too heavy or too big for storage in a vehicle, thus foldable handcarts have been developed later. However, this foldable design has also encountered some problems. One of them is to secure the cart at an open position for carrying goods.

A conventional handcart, Taiwanese patent publication number 383037, discloses a pair of small blocking plates used to stop wheels from folding inadvertently.

In order to carry heavy goods, the main frame of the conventional handcraft is provided with reinforcements which include a pair of side rods pivoted to respective sides of the main frame. Each side rod has the bottom end connected to a wheel. Although the prior art has disclosed a locating block, it is not applicable to a handcart for heavy goods.

### SUMMARY OF THE INVENTION

In view of this, the present invention relates to a handcart with a locating rod to prevent the handcart from folding inadvertently and to reinforce the structure when unfolding.

It is the primary object of the present invention to provide a locating structure of a handcart, which provides a locating rod. The locating rod is adapted to engage with the two side rods and to restrict the unfolded handcart from folding inadvertently.

It is another object of the present invention to provide a locating structure of a handcart, which is easy to operate. All the user has to do is to open the two side rods and to step the locating rod downward, and then the cart is ready to use.

It is a further object of the present invention to provide a locating structure of a handcart, which provides a poka-yoke function. The two side rods cannot be collapsed or folded if the locating rod is not pulled upward.

According to the present invention, there is provided a locating structure of a handcart, comprising:

a main frame comprising two longitudinal rods;

two side rods pivotally connected to the two longitudinal rods of the main frame, each of the side rods having a stop section which is spaced from the relative longitudinal rod of the main frame; and

a locating rod pivotally connected to the main frame, the locating rod having a pair of extension sections;

thereby, when the side rods and the locating rod are unfolded, the pair of extension sections leaning against the stop sections of the two side rods.

Preferably, the main frame further comprises a transverse bar connected between the two longitudinal rods, the stop section being a curved section, each of the two side rods further having an upper section and a lower end, the upper sections and the lower ends of the two side rods being pivotally connected to the longitudinal rods of the main frame respectively, the locating rod comprising a stop plate to engage with the transverse bar of the main frame when the locating rod is unfolded.

Alternatively, each of the side rods further has an upper section and a lower end, the stop section is located between the upper section and the lower end, the upper sections and the lower ends of the two side rods being pivotally connected to the two longitudinal rods of the main frame respectively, the stop section having a curved portion and a horizontal portion, the horizontal portion being provided with a stop block, the locating rod being pivotally connected to the two longitudinal rods of the main frame, when the locating rod is unfolded, the locating rod engaging with the stop block.

### BRIEF DESCRIPTION OF THE DRAWINGS

FIG. 1 is a perspective view of a first embodiment of the present invention;

FIG. 2 is a perspective view to show that the locating rod is folded;

FIG. 3 is a perspective view to show that the locating rod, the pair of side rods and the carry plate are folded;

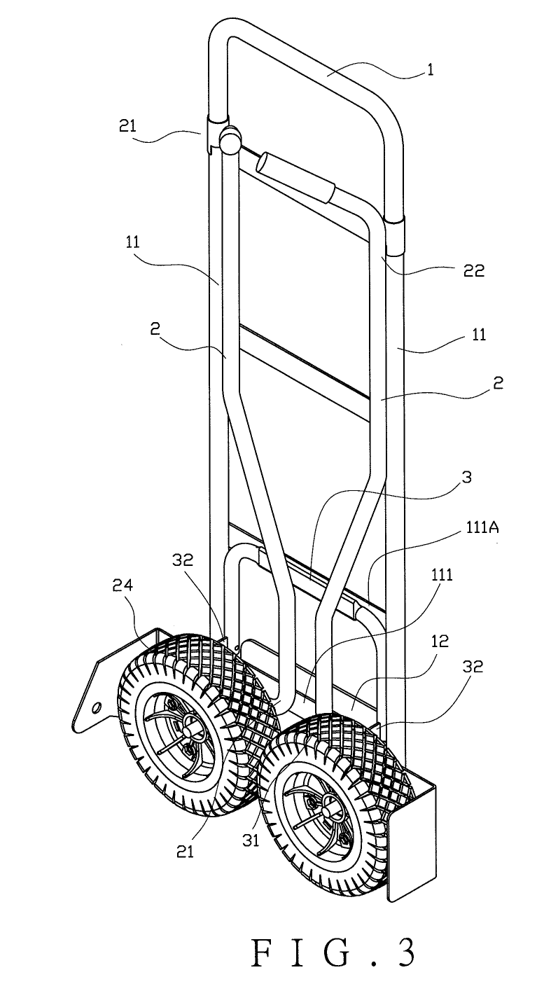

FIG. 4 is a perspective view of a second embodiment of the present invention;

FIG. 5 is a perspective view of the second embodiment to show that the locating rod is folded; and

FIG. 6 is a perspective view of the second embodiment to show that the locating rod, the pair of side rods and the carry plate are folded.

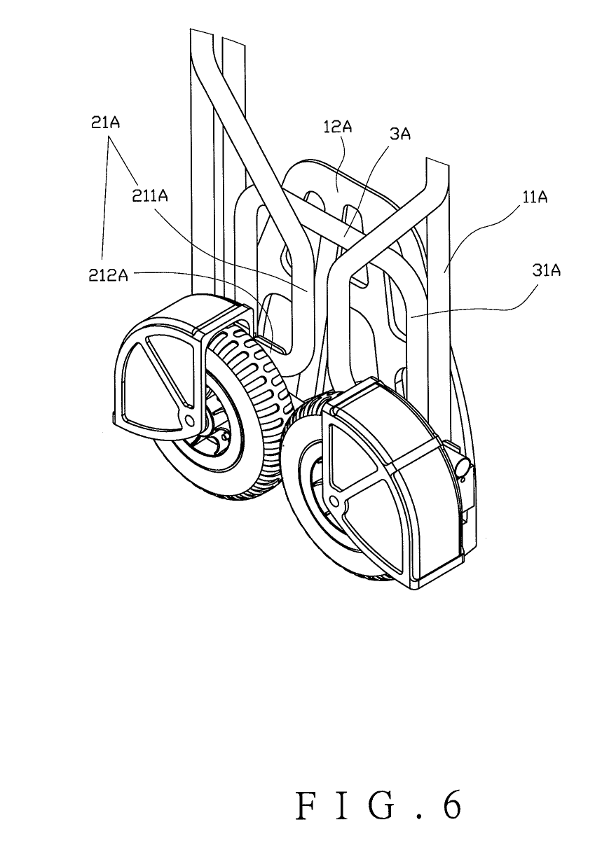

### DETAILED DESCRIPTION OF THE PREFERRED EMBODIMENT

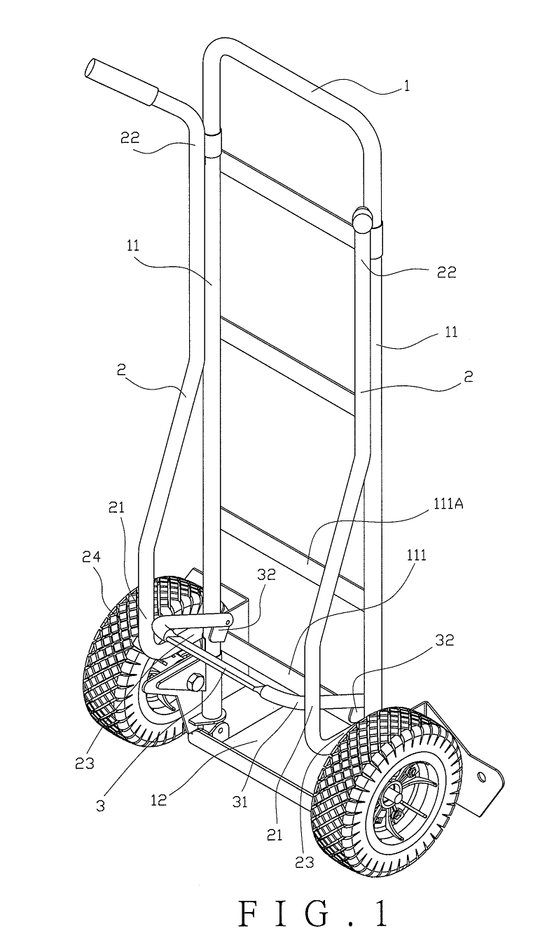

As shown in FIG. 1, the handcart according to a first embodiment of the present invention is made of common metal and comprises a main frame 1, two side rods 2, and a locating rod 3.

The main frame 1 comprises two parallel longitudinal rods 11 and a transverse bar 111 connected between the two longitudinal rods 11. A lower end of the main frame 1 is provided with a gear (not shown in the drawings) and connected with a carry plate 12. The gear and the carry plate 12 are not the novel features of this invention, and they will not be described hereinafter.

The two side rods 2 are pivotally connected to the two longitudinal rods 11 of the main frame 1, respectively. Each side rod 2 has an upper section 22, a lower end 23, and a stop section 21. The stop section 21 is a curved section. The upper section 22 and the lower end 23 of each side rod 2 are pivotally connected to the longitudinal rod 11 of the main frame 1, while the stop section 21 is spaced from the longitudinal rod 11. A top end of each side rod 2 has a handle thereat. The lower end 23 of each side rod 2 is provided with a gear (not shown in the drawing) to engage with the gear of the main frame 1. A wheel 24 is pivotally connected to the lower end of each side rod 2. Both the gear and the wheel 24 are not the novel features of this invention, and they will not be described hereinafter.

The locating rod 3 is shaped like an English letter U, and is pivotally connected to the two longitudinal rods 11 of the main frame 1. The locating rod 3 comprises a pair of extension sections 31 and a pair of stop plates 32 connected to the pair of extension sections 31.

As shown in FIG. 1, to unfold the locating rod 3, the two side rods 2 are turned towards two sides of the main frame 1 and the locating rod 3 is stepped downward, such that the stop plates 32 engage with the transverse bar 111 and the extension sections 31 of the locating rod 3 engage with the stop sections 21 of the two side rods 2 to prevent the handcart from collapsing or folding inadvertently.

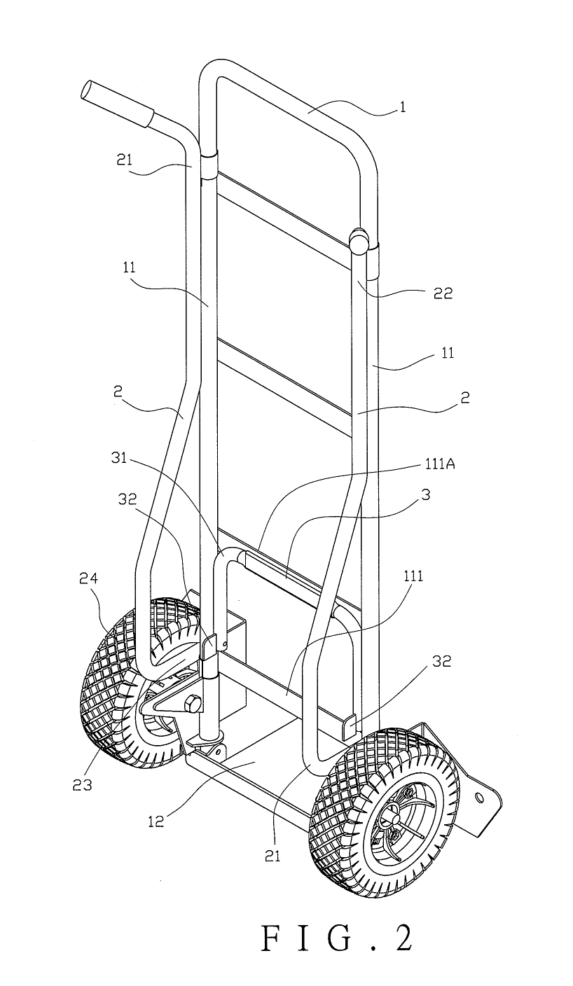

FIG. 2 is a perspective view showing the locating rod 3 in a collapsed or folded status. The locating rod 3 is pulled upward first, and then the carry plate 12 is pulled upward to collapse or to fold the two side rods 2 thereafter. The locating rod 3 can prevent the two side rods 2 from collapsing or folding inappropriately during operation.

In this embodiment, the main frame 1 further comprises another transverse bar 111A which is located above the transverse bar 111. When the locating rod 3 is pulled upward, the locating rod 3 will be contact with the stop plate 111A to keep the locating rod 3 in a straight status without leaning rearward.

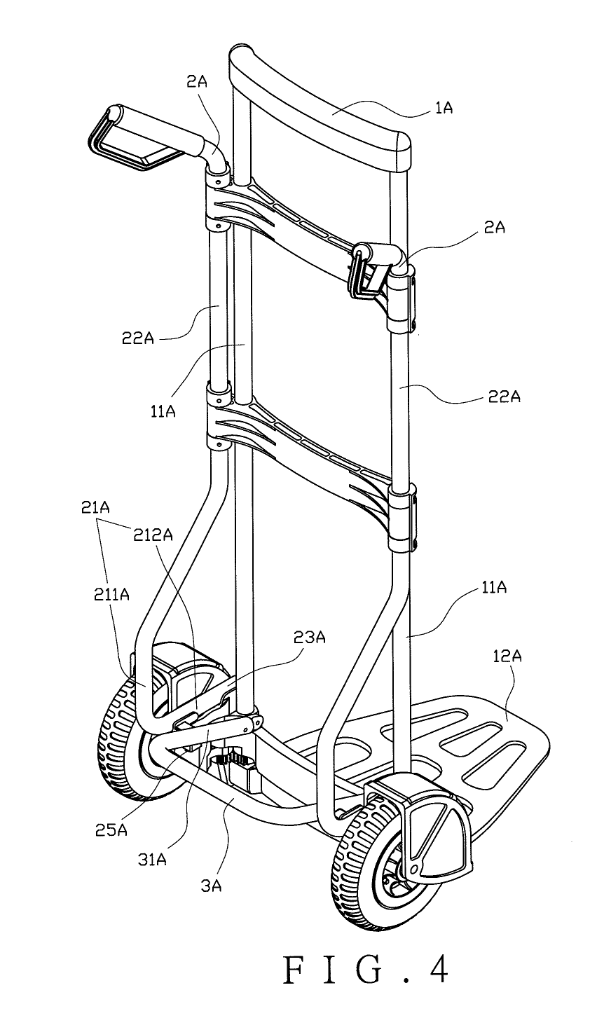

FIG. 4 shows a second embodiment of the present invention, wherein the handcart is made of common aluminum alloy and comprises a main frame 1A, two side rods 2A, and a locating rod 3A.

The main frame 1A comprises two longitudinal rods 11A and a transverse bar 111A connected between the two longitudinal rods 11A. A lower end of the main frame 1A is provided with a gear (not shown in the drawings) and connected with a carry plate 12A. The gear and the carry plate 12A are not the novel features of this invention, and they will not be described hereinafter.

The two side rods 2A are pivotally connected to the two longitudinal rods 11A of the main frame 1A, respectively. Each side rod 2A has an upper section 22A, a lower end 23A, and a stop section 21 between the upper section 22A and the lower end 23A. The upper section 22A and the lower end 23A of each side rod 2A are pivotally connected to the longitudinal rod 11A of the main frame 1A, while the stop section 21A is spaced from the longitudinal rod 11A. The stop section 21A has a curved portion 211A and a horizontal portion 212A. The horizontal portion 212A is provided with a stop block 25A.

The locating rod 3A is pivotally connected to the main frame 1A. The locating rod 3A comprises a pair of extension sections 31A which are pivotally connected to the two longitudinal rods 11A of the main frame 1A.

When the side rods 2A are unfolded, the locating rod 3A is positioned between the two side rods 2A, and the pair of the extension sections 31A engage with the stop blocks 25A of the stop sections 21A of the two side rods 2A to prevent the two side rods 2A from collapsing or folding inadvertently.

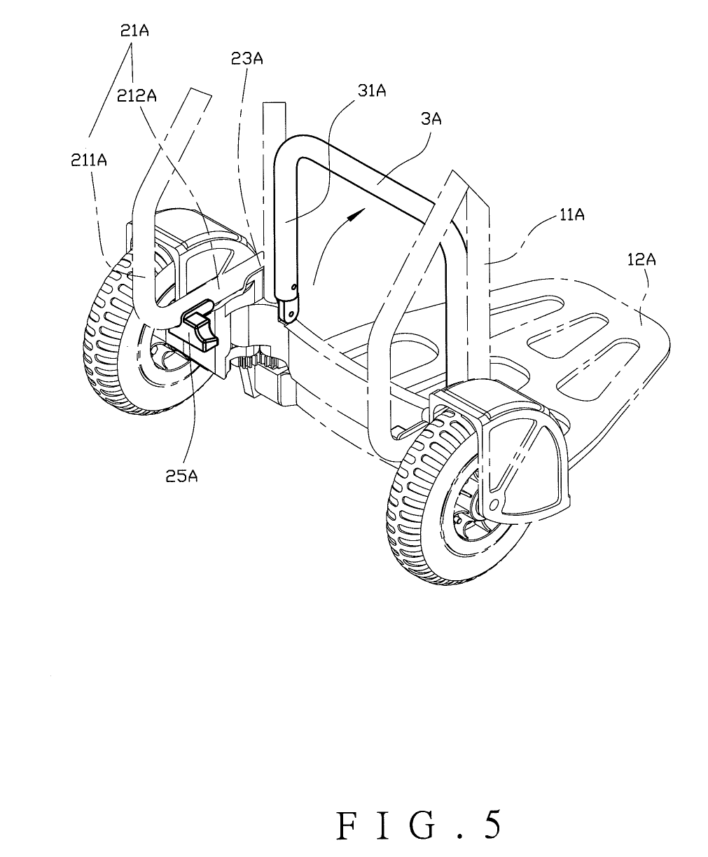

To collapse or to fold the handcart of the present invention, as shown in FIG. 5, the locating rod 3A needs to be pulled upward, and then the carry plate 12A is collapsed or folded upwardly as well, which allows the two side rods 2A to be collapsed or folded. The design of the locating rod 3A prevents the two side rods 2A from collapsing or folding inadvertently.

Although the terms and expressions which have been employed and used as terms of description and not of limitation and there is no intention in the use of such terms and expressions of excluding any requirement of the features shown and described, or portions thereof, but it is recognized that various modifications are possible within the scope of the invention claimed.

What is claimed is:

1. A locating structure of a handcart, comprising:
a main frame comprising two longitudinal rods;
two side rods pivotally connected to the two longitudinal rods of the main frame, each of the side rods having a stop section which is spaced from the relative longitudinal rod of the main frame; and
a locating rod pivotally connected to the main frame, the locating rod having a pair of extension sections;
thereby, when the side rods and the locating rod are unfolded, the pair of extension sections engaging with the stop sections of the two side rods.

2. The locating structure of a handcart as claimed in claim 1, wherein the main frame further comprises a transverse bar connected between the two longitudinal rods, the stop section being a curved section, each of the two side rods further having an upper section and a lower end, the upper sections and the lower ends of the two side rods being pivotally connected to the two longitudinal rods of the main frame respectively, the locating rod comprising a stop plate to engage with the transverse bar of the main frame when the locating rod is unfolded.

3. The locating structure of a handcart as claimed in claim 1, wherein each of the side rods further has an upper section and a lower end, the stop section is located between the upper section and the lower end, the upper sections and the lower ends of the two side rods being pivotally connected to the two longitudinal rods of the main frame respectively, the stop section having a curved portion and a horizontal portion, the horizontal portion being provided with a stop block, the locating rod being pivotally connected to the two longitudinal rods of the main frame, when the locating rod is unfolded, the locating rod engaging with the stop block.
